(19) United States
(12) Patent Application Publication
(10) Pub. No.: US 2007/0261281 A1
(43) Pub. Date: Nov. 15, 2007

(54) Screen Door Indicator Sign

(76) Inventor: Mark P. Roberge, Manchester, NH (US)

Correspondence Address: MESMER & DELEAULT, PLLC, 41 BROOK STREET, MANCHESTER, NH, 03104, US

(21) Appl. No.: 11/383,342

(22) Filed: May 15, 2006

(51) Int. Cl. G09F 7/04

(52) U.S. Cl. 40/600

(57) ABSTRACT

A visual indicator device to indicate the presence of a screen has a surface indicator having a display side and an indicator back side containing magnetic material and a securing member having a securing member back side containing a magnetic material. The indicator back side is sized for placement against a side of the screen. The securing member is configured for placement against an opposite side of the screen opposite the indicator back side where the magnetic material of the surface indicator and the magnetic material of the securing member attract each other.

### BACKGROUND OF THE INVENTION

1. Field of the Invention

The present invention relates generally to signs. Particularly, the present invention relates to warning signs. More particularly, the present invention relates to a sign for indicating/warning the presence of an object.

2. Description of the Prior Art

Indicator devices such as signs have been used throughout the ages to provide people with information or to warn them of potential hazards or consequences. Indicator devices/signs are now available to meet a variety requirements. These include architectural and front office signs, electronic signs and displays, first aid signs, informational and housekeeping signs, no smoking signs, security signs, traffic and parking signs, warehouse and facility signs, bilingual signs, Braille and handicap accessible signs, fire, exit and evacuation signs, floor signs, lockout and electrical signs, OSHA and regulatory signs, sprinkler and valve signs, truck and vehicle signs, etc. Some of these signs are designed to be mounted on doors.

Several indicator or warning devices have been disclosed that relate particularly to doors such as automobile and garage doors.

U.S. Pat. No. 6,690,287 B2 (2004, Jette et al.) discloses a safety system for entering and exiting garage doors and entrances comprising a warning sign that is adapted to be placed in the primary line of sight of a driver during the lowering and raising movements of a garage door. A delay circuit facilitates movement of the sign on an attachment cable so that the sign will always appear in the primary line of sight of the driver. A moving mechanism is adapted to lower the sign into an operational position and to keep the sign in a non-operational retracted position when the door is completely open to ensure clearance for the moving vehicle.

U.S. Pat. No. 4,833,448 (1989, Chang) discloses a warning device installed on an automobile to produce a warning sign visible to passers-by when opening the automobile door. The device includes a door lock, a door lock switch operable with the door lock, a relay that is operable by the door lock switch to turn on warning lights that are installed in the front and rear ends of the automobile, and a blinker for causing the warning lights to blink.

U.S. Pat. No. 6,337,623 B1 (2002, Krugh, IV et al.) discloses a supplemental warning sign for school buses which are mounted on the roof of the vehicle. The warning apparatus includes a display member carried by a base member in either a retracted position or in an upright vertically extended position so that it can be seen by surrounding traffic.

UK Patent Application GB 2,387,951 A (2003, Brooksbank) discloses a thermochromic fire warning sign for detecting fire through a door. A sign is comprised of a substrate having an information legend which is masked by a thermochromic material so that the legend is unreadable. Upon heating above an activation threshold, the thermochromic material becomes transparent and the legend becomes visible. The sign is fixed by a high-temperature stable, thermally conductive adhesive.

While all these systems are used as an indicator apparatus for a door, they do not address the specific concerns for a screen door. Screen doors are commonly used as a secondary exterior door on a house. When the main door is open, the screen door allows ventilation and light to come into the house. The screen door also allows the homeowner to enjoy the outdoors while maintaining a barrier between outdoor elements, particularly insects, and the inside of the house.

One type of door common to many houses is the slider door. Slider doors are typically used where doors open onto a deck or patio. Slider doors typically include a separate sliding screen door to keep out insects when the slider door is open. Sliding screen doors typically include a frame around the doors outer periphery with rollers on the top and bottom of the frame to facilitate sliding of the screen door and a screen panel extending between the inside of the frame and secured to the frame. The frame is typically made of a light but sturdy material such as aluminum or wood and supports the screen panel. The screen panel is typically a flexible mesh panel made of metal or plastic.

The screen mesh panel makes up a major portion of the screen door. Under certain conditions, the screen door can appear transparent to a person approaching the screen door to enter or exit a house. People and pets, therefore, can inadvertently walk into the door. Under other conditions such as a first person going out or in to get something and leaving the door open expecting to return shortly, a second person closes the door to be helpful only to discover that the first person walks into the closed screen door because the screen mesh is not seen and that person was expecting the door to be open. Oftentimes, this cannot only hurt the person or pet but also damage the screen door.

Therefore, what is needed is a visual indicator device that draws attention to the presence of the screen door. What is also needed is a visual indicator device that will not damage the screen mesh panel of the screen door. What is further needed is a visual indicator device that will not interfere with the proper operation of the sliding door.

### SUMMARY OF THE INVENTION

It is an object of the present invention to provide a visual indicator device that draws attention to the presence of a screen door. It is another object of the present invention to provide a visual indicator device that will not damage the screen mesh pane of a screen sliding door. It is a further object of the present invention to provide a visual indicator device that does not interfere with the proper operation of the sliding screen door.

The present invention achieves these and other objectives by providing an indicator sign adapted for mounting on a screen of a screen door and having physical properties that cause it to be noticed by someone approaching the screen door. The indicator sign has a surface indicator adapted for placement against one side of a screen and a securing member adapted for placement against a side of the screen opposite the surface indicator. The surface indicator has a display side and a back side that includes an indicator magnetic material. The indicator magnetic material may be any permanently magnetized or magnetizable material. The securing member has a member back side that also includes a permanently magnetized or magnetizable material. The strength of the attractive forces created by the magnetic field of the indicator magnetic material and the member magnetic material when in their opposed relationship on the screen must be sufficient to hold the indicator sign in place on the screen.

The surface indicator can be made of any material but is preferably made from a light-weight, durable material so that less magnetic force is required to hold the surface indicator in position against the screen. The lesser the amount of magnetic force required, the less expensive are the materials per indicator sign, which in turn provides economic benefits. The indicator sign may be placed anywhere on the screen but is preferably placed substantially centered and at approximately eye level. Any message, symbol, coloration, or combinations thereof may be on the display side of the surface indicator so long as the indicator sign catches the attention of an individual approaching the screen door. The securing member may optionally include a member display side that may also have the same or different message, symbol, and coloration.

To provide a whimsical characteristic to the indicator sign, the component that is positioned on the screen's outside surface may be any thickness and shape since there is no constraint that would interfere with the sliding screen doors operation like there is for the component positioned on the screen's inside surface. The only limited factor is that the type and size of magnetic material used must provide a magnetic force sufficient to support the particular indicator sign. For example, the securing member may be half of a tennis ball or a stuffed animal or any other item that would provide a lighthearted visual that would appear to defy logic and science.

### BRIEF DESCRIPTION OF THE DRAWINGS

FIG. 1 is a perspective view of the screen door indicator sign of the present invention in use on a screen door.

FIG. 2 is an enlarged, side view of a portion of the screen door indicator sign of the present invention in use on a screen door.

FIG. 3 is a front view of the screen door indicator sign of the present invention in use on a screen door.

FIG. 4 is a front view of the surface indicator of the screen door indicator sign of the present invention.

FIG. 5 is a side view of the surface indicator of the screen door indicator sign of the present invention.

FIG. 6 is a back view of the surface indicator of the screen door indicator sign of the present invention.

### DETAILED DESCRIPTION OF THE PREFERRED EMBODIMENT

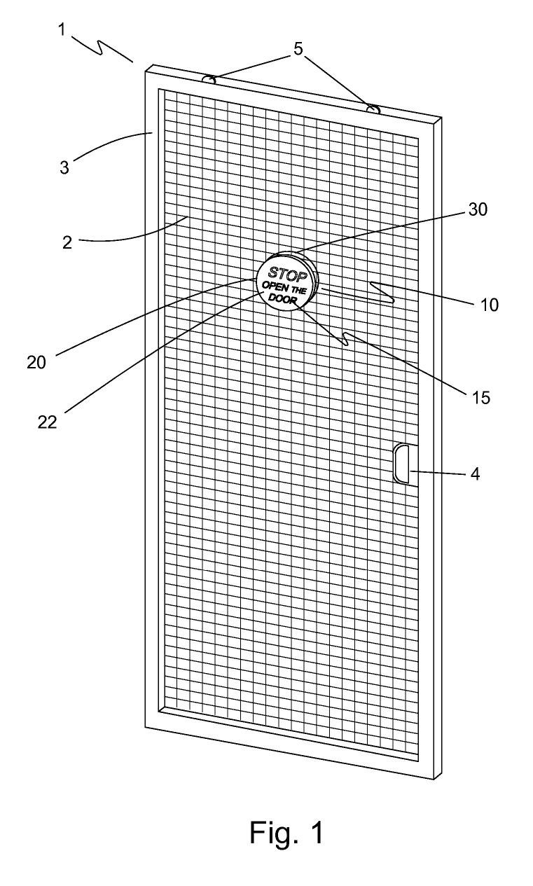

The preferred embodiment(s) of the present invention is illustrated in FIGS. 1-6. FIG. 1 illustrates a perspective view of one embodiment of the visual indicator device 10 of the present invention in use on a screen door. Screen door 1 is a typical sliding screen door found on glass sliding doors. Screen door 1 typically includes a screen mesh panel 2, mesh panel frame 3, a screen door handle 4, and a plurality of top and bottom screen door rollers 5. Visual indicator device 10, which is also called a screen door indicator sign, includes a surface indicator 20 and a securing member 30. Surface indicator 20 has an indicator display side 22 and a back side 24 (not shown). Indicator display side 22 has a visual indicia 15 disposed on indicator display side 22. Visual indicia 15 may be formed as an integral part of the surface of indicator display side 22, or disposed on or attached to display side 22 or a combination thereof. Back side 24 of surface indicator 20 contains an indicator magnetic material 26 (not shown). Indicator magnetic material 26 is preferably a permanently magnetized or magnetizable material. More preferably, indicator magnetic material 26 is a magnet. Surface indicator 20 may be made of any material, but it is preferable that the material chosen is lightweight so that a lesser magnetic force is required to hold surface indicator 20 in position on screen mesh panel 3.

Securing member 30 typically has a back side 32 that also contains a member magnetic material 36 (not shown). Like indicator magnetic material 26, member magnetic material 36 is preferably a permanently magnetized or magnetizable material. More preferably member magnetic material 36 is a magnet. Display side 22 of surface indicator 20 is typically attached on the inside of screen door 1 facing the interior of the house with back side 24 against screen mesh panel 2 of screen door 1. Securing member 30 is typically attached on the outside of screen door 1 facing the exterior of the house with back side 34 against screen mesh panel 2 of screen door 1. Indicator magnetic material 26 and member magnetic material 36 typically generate a magnetic field strong enough to attract and hold surface indicator 20 to securing member 30, and vice versa, in position on opposite sides of screen mesh panel 2 of screen door 1.

Securing member 30 can simply be a piece of a magnetic material or a magnet to ensure that surface indicator 20 is held in place on the opposite side of screen door 1. Optionally, securing member 30 may have a member display side 32 to serve as a second surface indicator. By including an optional member display side 32, visual indicia 15 may also be disposed on member display side 32 providing a similar notification function on each side of screen door 1. Securing member 30 can be sized to any dimension and any shape so long as the magnetic field is strong enough to hold itself and surface indicator 20 in their respective positions against screen mesh panel 2 of screen door 1. Like surface indicator 20, securing member 30 may be made of any material but it is preferable that the material is lightweight so that a lesser magnetic force is required to maintain its position against screen mesh panel 2.

It should be understood that the placement of surface indicator 20 and securing member 30 can also be reversed. In other words, surface indicator 20 can be placed on the outside of screen door 1 and securing member 30 can be placed on the inside of screen door 1. One critical aspect of visual indicator device 10 is that the component (i.e. surface indicator 20 or securing member 30) placed on the inside of screen door 1 must be no thicker than the thickness of screen mesh frame 3 of screen door 1 so that it will not interfere with the sliding operation of screen door 1.

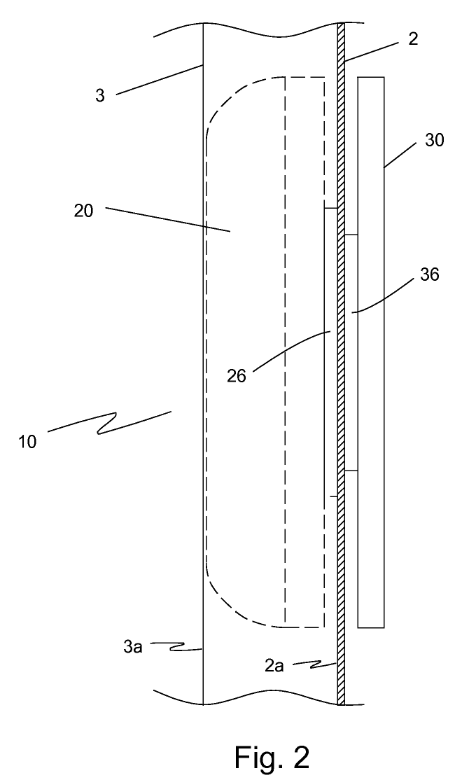

Turning now to FIG. 2, there is illustrated an enlarged side view of the visual indicator device 10 positioned on screen door 1. Surface indicator 20 is mounted on the inside of screen door 1. This is evidenced by the position of surface indicator 20 relative to the positions of the screen mesh frame 3 and screen mesh panel 2. As shown in FIG. 2, surface indicator 20 has a thickness no greater than the distance between an inside surface 3a of screen mesh frame 3 and an inside surface 2a of screen mesh panel 2. This allows screen door 1 to slide between a closed and an open position on a sliding door without interference from surface indicator 20. Indicator magnetic material 26 and member magnetic material 36 are preferably disproportionate in size to permit easy visualization of the relative positions of the magnetized or magnetizable materials. It should be understood that indicator magnetic material 26 may be embedded into the back side 24 of surface indicator 20, or it may be layered onto back side 24, or the entire surface indicator 20 may be made of such material. The critical concept is that visual indicator device 10 is retained in place on screen mesh panel 2 using a magnetic force between surface indicator 20 positioned on one side of screen mesh panel 2 and securing member 30 positioned on the opposite side of screen mesh panel 2.

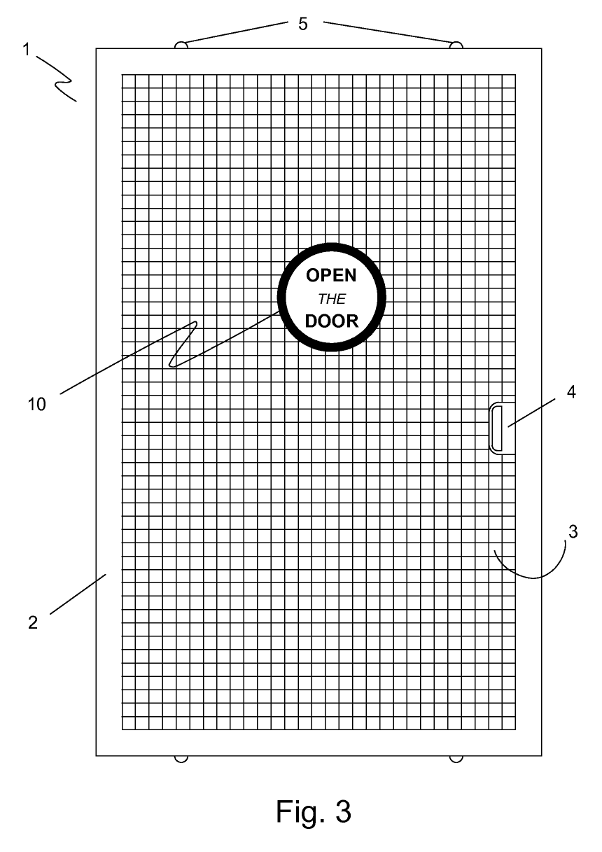

Turning now to FIG. 3, there is illustrated a front view of the surface indicator of the screen door indicator sign of the present invention. Surface indicator 20 is attached to screen mesh panel 2 of screen door 1 by securing mechanism 30 (not shown). Surface indicator 20 can be placed anywhere on screen mesh panel 2 of screen door 1, but is preferably placed substantially centered and at approximately eye level as shown in FIG. 3. In the illustration in FIG. 3, surface indicator 20 is inscribed with a message to “Open the Door.” Any message or symbol or combination thereof, however, may be on surface indicator 20 or no message or symbol at all, so long as surface indicator 20 is designed to catch the attention of the individual approaching screen door 1. For example, bold colors may be used to catch a person's attention or a three dimensional object can be used as a whimsical indicator that the screen door is closed. Additionally, display side 22 can contain pictures or phrases to draw the attention of the individual approaching the screen door.

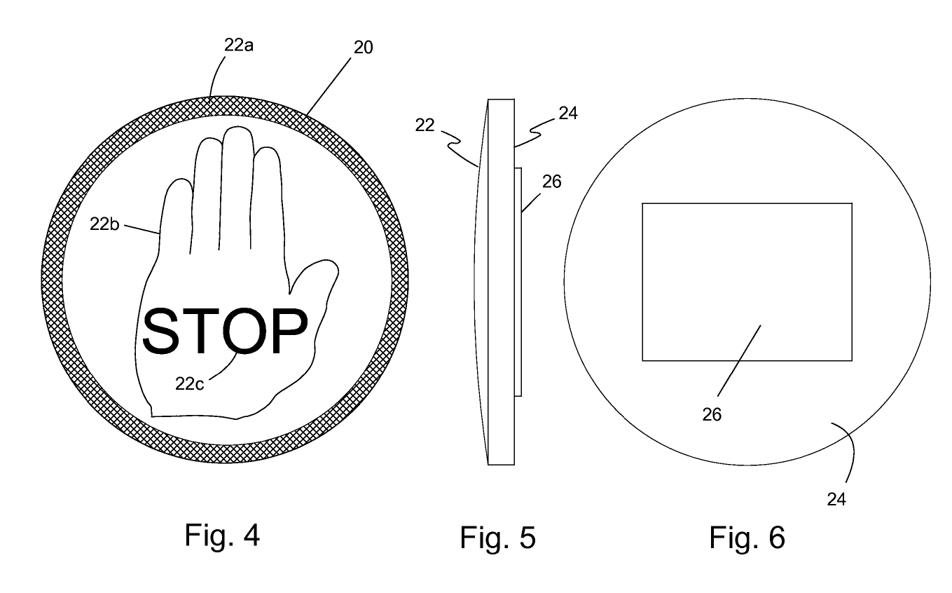

FIG. 4 is a front view of surface indicator 20. Surface indicator 20 can be shaped in any way and is not limited to the circular shape shown. As described above, surface indicator 20 can contain any message, color, or dimension in order to catch the attention of the individual approaching the screen door. As illustrated in FIG. 4, surface indicator has a circular shape containing a border 22a that may be a bold color, a hand outline 22b symbolizing a visual stop command and the word “STOP” 22c to attract the attention of someone approaching a screen door that has the present invention mounted thereon. Surface indicator 20 can also be made of any material, but is preferably a light-weight, non-breakable material. Additionally, the size and weight of surface indicator 20 is limited only by the surface area of the door and the strength of the magnetic field used to hold surface indicator 20 in place. The strength of the magnetic field is determined by the type of magnetic material used on both the surface indicator 20 and securing member 30 and the size/surface area of the magnetic material.

FIG. 5 is a side view of surface indicator 20. Surface indicator 20 is shown having display side 22 and back side 24. Display side 22 faces away from screen door 1 (not shown). Back side 24 is connected to magnetic material 26, as also shown in FIG. 6. It should be understand by those of ordinary skill the art that magnetic material 26 can be placed within or onto back side 24 of surface indicator 20 or back side 24 can be made of a ferrous material such that part or all of back side 24 serves as magnetic material 26.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

What is claimed is:

1. A visual indicator device to indicate the presence of a screen, said device comprising:
a surface indicator having a display side and a indicator back side, said indicator back side containing a magnetic material, said surface indicator being sized for placement against a side of said screen; and
a securing member having a securing member back side containing a magnetic material, said securing member configured for placement against an opposite side of said screen opposite said indicator back side wherein said magnetic material of said surface indicator and said magnetic material of said securing member attract each other.

2. The visual indicator device of claim 1 wherein said securing member has a display side.

3. The visual indicator device of claim 1 wherein said magnetic material of said surface indicator and said magnetic material of said securing member create an attractive magnetic field sufficient to hold said visual indicator device in place on said screen.

4. The visual indicator device of claim 1 wherein said screen has a frame with a predefined frame depth wherein said screen is attached to one side of said frame and wherein said surface indicator has a thickness no greater than said frame depth.

5. The visual indicator device of claim 4 wherein said surface indicator is positioned within said frame depth.

6. A screen door indicator sign kit for attaching to a sliding screen door having a screen frame and a screen disposed across the screen frame, said kit comprising:
a surface indicator having a display side and an indicator back side containing an indicator magnetic material, said surface indicator adapted for placement against one side of the screen;
a securing member having a securing member back side containing a magnetic material, said securing member adapted for placement against a side of the screen opposite said indicator back side; and
instructions for attaching said surface indicator and said securing member on said screen.

7. The kit of claim 6 wherein said magnetic material is a magnet.

8. The kit of claim 6 wherein said magnetic material of said surface indicator and said magnetic material of said securing member create a magnetic field sufficient to hold said visual indicator device in place on said screen.

9. The kit of claim 6 wherein said surface indicator has a thickness no greater than the thickness of the screen frame.

10. In combination, a sliding screen door and an indicator sign, said combination comprising:
a sliding screen door having a mesh panel frame and a screen mesh panel;
a surface indicator having a display side and a back side containing a magnetic material, said surface indicator mounted against one side of said screen mesh panel; and
a securing member having a back side containing a magnetic material, said securing member mounted against a side of said screen mesh panel opposite said indicator back side wherein said magnetic material of said surface indicator and said magnetic material of said securing member attract each other.

11. The combination of claim 9 wherein said securing member has a member display side.

12. The combination of claim 9 wherein said magnetic material of said surface indicator and said magnetic material of said securing member create a magnetic field sufficient to hold said indicator sign in place on said sliding screen door.

13. The combination of claim 9 wherein said surface indicator has a thickness no greater than the thickness of said mesh panel frame.
